(19) United States
(12) Patent Application Publication
(10) Pub. No.: US 2009/0300451 A1
(43) Pub. Date: Dec. 3, 2009

(54) Frame transferring apparatus and frame transferring system

(75) Inventor: Masakatsu Koyanagi, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/379,054

(22) Filed: Feb. 11, 2009

(30) Foreign Application Priority Data
Jun. 3, 2008 (JP) 2008-145984

(51) Int. Cl. H04L 1/18; G06F 11/14

(52) U.S. Cl. 714/748; 714/E11.113

(57) ABSTRACT

A frame transferring apparatus includes a check-frame storage unit that has temporarily stored therein a reception check frame; a check-frame transmitting unit that transmits a transmission check frame to another frame transferring apparatus; a check-frame discarding unit that, when a storage space for storing the reception check frame is left in the check-frame storage unit, stores the reception check frame in the check-frame storage unit and, when no storage space is left, discards the reception check frame; a transferring-apparatus-information obtaining unit that obtains frame-transferring-apparatus information; a checking unit that checks a non-arrival of a frame based on the frame-transferring-apparatus information; a retransmission requesting unit that, when the reception check frame is discarded, requests the frame transferring apparatus of a transmission source of the discarded check frame to retransmit a check frame; and a check-frame retransmitting unit that, when accepting a request for retransmitting the transmission check, retransmits the check frame.

### CROSS-REFERENCE TO RELATED APPLICATION(S)

This application is based upon and claims the benefit of priority of the prior Japanese Patent Application No. 2008-145984, filed on Jun. 3, 2008, the entire contents of which are incorporated herein by reference.

### FIELD

The present invention relates to a frame transferring apparatus and frame transferring system.

### BACKGROUND

Conventionally, a frame transferring apparatus that transfers a frame is provided with a check mechanism called Ethernet (registered trademark) Operations Administration Maintenance (Ether OAM) for checking a non-arrival of a frame transferred among frame transferring apparatuses (in other words, for checking continuity of a logical line path on a network) (see Japanese Laid-open Patent Publication No. 2007-251541).

Specifically, Ether OAM is a mechanism that determines whether a Continuity Check Message (CCM) frame for checking a non-arrival of a frame has regularly been received from other frame transferring apparatuses connected via a network, thereby determining whether all frames issued from the other frame transferring apparatuses have been reliably received.

In the following, the process by a conventional frame transferring apparatus is explained by using FIG. 14 with a specific example. FIG. 14 is a drawing for explaining general outlines of the conventional frame transferring apparatus.

As depicted in (1) of FIG. 14, a frame transferring apparatus generates a CCM frame every time a transmission timing counter value obtained by starting count-up after a CCM frame is transmitted last time reaches a predetermined counter value set in advance as a transmission interval. Here, the transmission interval is a time interval parameter-specified in advance as a period of transmitting a CCM frame.

The frame transferring apparatus then transmits the generated CCM frame to another frame transferring apparatus connected via a network.

Also, as depicted in (2) of FIG. 14, when a storage space for storing a CCM frame is left in a buffer, a CCM frame received from another frame transferring apparatus is stored in the buffer. When no storage space is left in the buffer, the CCM frame received from another frame transferring apparatus is discarded.

Concurrently with this storing process, as depicted in (3) of FIG. 14, the frame transferring apparatus analyzes the CCM frame read and deleted from the buffer, and obtains an apparatus identification (ID) for identifying a frame transferring apparatus of a transmission source of the CCM frame.

Every time a monitoring cycle counter value obtained by starting count-up after a non-arrival of a frame is checked last time reaches a predetermined counter value set in advance as a monitoring interval, the frame transferring apparatus determines whether all apparatus IDs of other frame transferring apparatuses have been obtained by the time when the monitoring cycle counter value reaches the counter value as the monitoring interval.

Here, when there is an apparatus ID not yet obtained among the apparatus IDs of the frame transferring apparatuses to be obtained, the frame transferring apparatus issues an alarm indicating that a non-arrival of a frame transferred among the frame transferring apparatuses is detected. The monitoring interval is a time interval parameter-specified in advance as a period of checking a non-arrival of a frame.

Meanwhile, in the conventional technology, a non-arrival of a frame may be erroneously detected. That is, the conventional frame transferring apparatus discards the CCM frame received when a storage space is not left, and does not obtain the apparatus ID from the discarded CCM frame.

Therefore, based on the determination result that there is an apparatus ID not yet obtained among the apparatus IDs of the frame transferring apparatuses to be obtained, the frame transferring apparatus determines that a CCM frame that should be regularly received has not been received from the frame transferring apparatus of the transmission source of the discarded CCM frame, thereby disadvantageously causing an erroneous detection of a non-arrival of a frame.

Here, this problem can be solved by having a device capable of analyzing a CCM frame at a processing speed higher than a frame transfer speed or a buffer capable of storing all received CCM frames implemented in the conventional frame transferring apparatus. However, this is not a practical solution in view of cost.

### SUMMARY

According to an aspect of the invention, a frame transferring apparatus includes a check-frame storage unit that has temporarily stored therein a reception check frame for checking a non-arrival of a frame transferred among frame transferring apparatuses that transfer a frame; a check-frame transmitting unit that transmits a transmission check frame to each of other frame transferring apparatuses connected via a network every time a post-transmission elapsed-time counter value indicative of an elapsed time from a time when a transmission check frame is transmitted last time reaches a predetermined value set in advance; a check-frame discarding unit that, when a storage space for storing the reception check frame is left in the check-frame storage unit, stores the reception check frame received from the other frame transferring apparatus in the check-frame storage unit and, when no storage space for storing the reception check frame is left in the check-frame storage unit, discards the reception check frame received from the other frame transferring apparatus; a first transferring-apparatus-information obtaining unit that obtains, from the reception check frame read and deleted from the check-frame storage unit, frame-transferring-apparatus information for identifying the frame transferring apparatus of a transmission source of the reception check frame; a checking unit that, every time a post-check elapsed-time counter value indicative of a check elapsed time from a time when a non-arrival of a frame is checked last time reaches a predetermined value set in advance, checks a non-arrival of a frame transferred among the other frame transferring apparatuses based on the frame-transferring-apparatus information obtained by the first transferring-apparatus-information obtaining unit by the time when the post-check elapsed-time counter value reaches the predetermined value; a retransmission requesting unit that, when the reception check frame is discarded by the check-frame discarding unit, requests the frame transferring apparatus of a transmission source of the discarded check frame to retransmit a check frame; and a check-frame retransmitting unit that, when accepting a request for retransmitting the transmission check frame from the other frame transferring apparatus, retransmits the transmission check frame to the frame transferring apparatus of a requesting source.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a drawing for explaining general outlines and features of frame transferring apparatuses according to a first embodiment;

FIG. 2 is a drawing for explaining general outlines and features of the frame transferring apparatus according to the first embodiment;

FIG. 3 is a block diagram of the configuration of the frame transferring apparatus;

FIG. 4 is a flowchart depicting a flow of a CCM-frame transmitting process;

FIG. 5 is a flowchart depicting a flow of a frame receiving process;

FIG. 6 is a flowchart depicting a flow of a non-arrival checking process;

FIG. 7 is a flowchart depicting a flow of a frame receiving process by a frame transferring apparatus according to a second embodiment;

FIG. 8 is a drawing for explaining an effect of the second embodiment;

FIG. 9 is a block diagram of the configuration of a frame transferring apparatus according to a third embodiment;

FIG. 10 is a flowchart depicting a flow of a frame receiving process by the frame transferring apparatus according to the third embodiment;

FIG. 11 is a flowchart depicting a flow of a retransmission-request-frame transmitting process by the frame transferring apparatus according to the third embodiment;

FIG. 12 is a drawing for explaining an effect of the third embodiment;

FIG. 13 is a drawing for explaining an effect of a fourth embodiment; and

FIG. 14 is a drawing for explaining general outlines of a conventional frame transferring apparatus.

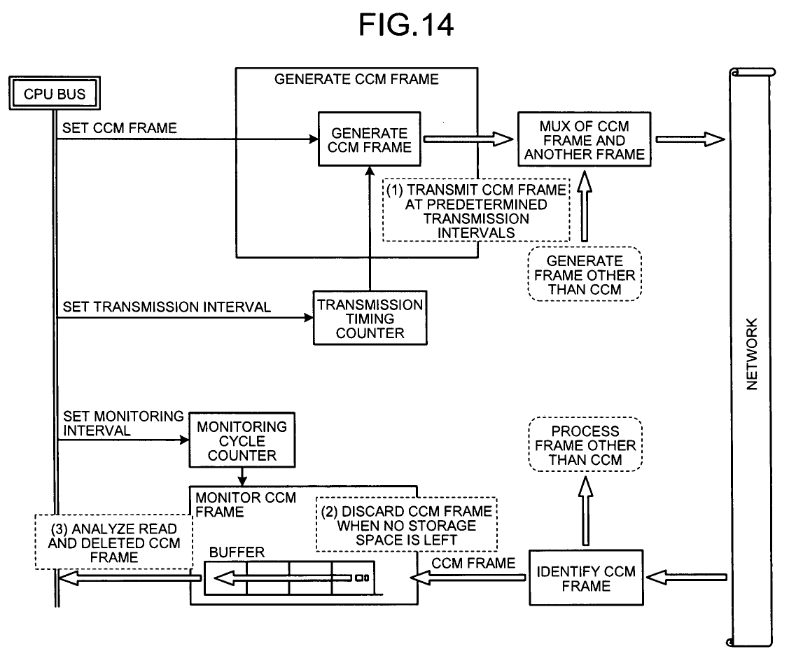

### DESCRIPTION OF EMBODIMENT(S)

With reference to the attached drawings, embodiments of the frame transferring apparatus and frame transferring system according to the present invention are explained in detail below. In the following, a frame transferring apparatus to which the present invention is applied is explained as an embodiment.

### [a] First Embodiment

In a first embodiment, general outlines and features of a frame transferring apparatus according to the first embodiment, the configuration of the frame transferring apparatus, and then a flow of the process of the frame transferring apparatus are explained, and finally effects of the first embodiment is explained.

### General Outlines and Features of the Frame Transferring Apparatus According to the First Embodiment

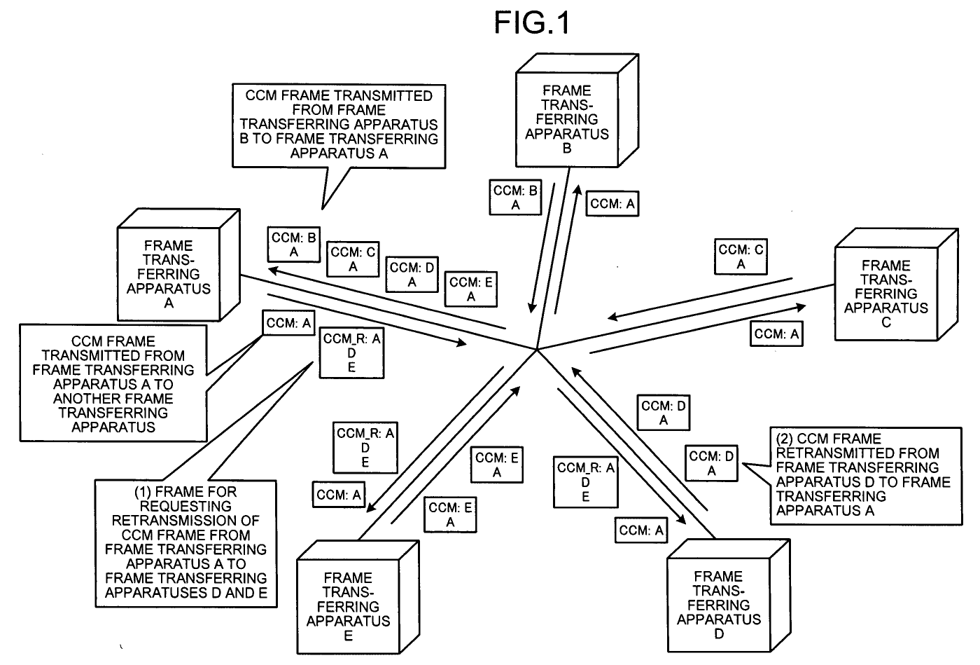

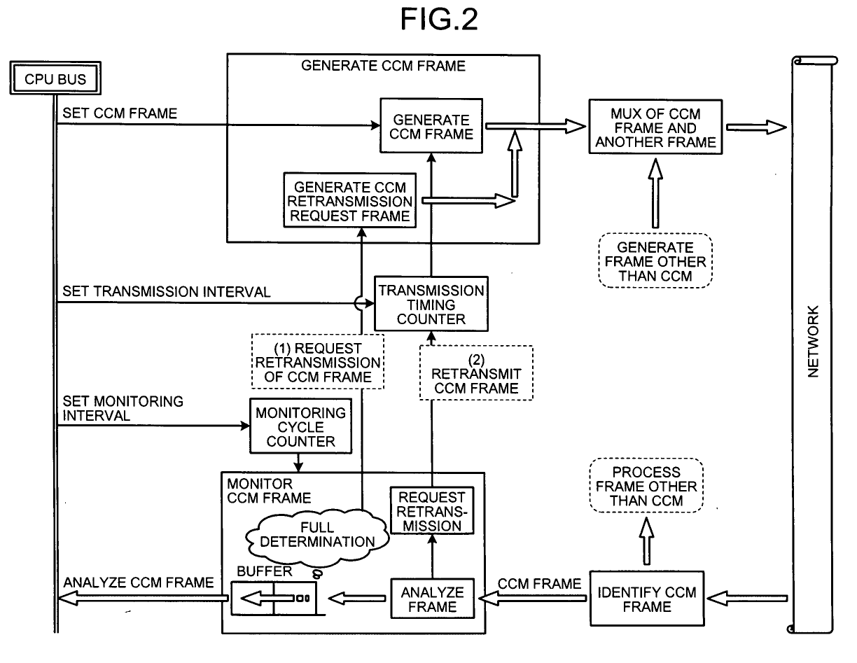

First, general outlines and features of the frame transferring apparatus according the first embodiment are explained by using FIGS. 1 and 2. FIG. 1 is a drawing for explaining general outlines and features of frame transferring apparatuses according to a first embodiment, and FIG. 2 is a drawing for explaining the general outlines and features of each of the frame transferring apparatuses according to the first embodiment.

As depicted in FIG. 1, each of the frame transferring apparatuses according to the first embodiment transmits CCM frames (transmission CCM frames) for checking a non-arrival of a frame to another frame transferring apparatuses connected via a network.

Also, as depicted in FIG. 2, the frame transferring apparatus according to the first embodiment analyzes CCM frames (reception CCM frames) received from the other frame transferring apparatuses to check a non-arrival of a frame transferred among the frame transferring apparatuses of transmission sources of the CCM frames.

Under such general outlines, the frame transferring apparatus according to the first embodiment prevents an erroneous detection of a non-arrival of a frame.

Specifically, as depicted in (1) of FIG. 2, when a storage space for storing a CCM frame is not left in a buffer and a CCM frame received from another frame transferring apparatus is discarded, the frame transferring apparatus according to the first embodiment requests the frame transferring apparatus of a transmission source of the discarded CCM frame to retransmit a CCM frame.

For example, as depicted in FIG. 1, a frame transferring apparatus A transmits retransmission request frames for requesting retransmission of a CCM frame to frame transferring apparatuses D and E, which are frame transferring apparatuses of transmission sources of discarded CCM frames.

Also, as depicted in (2) of FIG. 2, when accepting a request for retransmitting a CCM frame from another frame transferring apparatus, the frame transferring apparatus according to the first embodiment retransmits the CCM frame to the frame transferring apparatus of a requesting source.

For example, as depicted in FIG. 1, the frame transferring apparatuses D and E accepting a retransmission request frame from the frame transferring apparatus A retransmit a CCM frame to the frame transferring apparatus A.

From this, the frame transferring apparatus according to the first embodiment can prevent an erroneous detection of a non-arrival of a frame.

[Configuration of the Frame Transferring Apparatus]

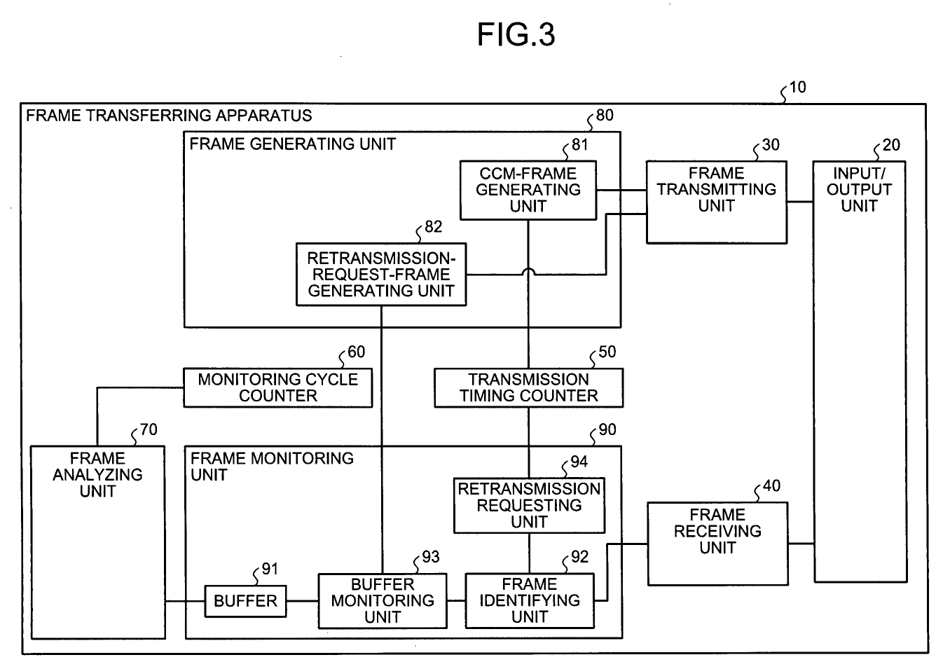

Next, the configuration of a frame transferring apparatus 10 corresponding to the frame transferring apparatuses A to E depicted in FIGS. 1 and 2 is explained by using FIG. 3. FIG. 3 is a block diagram of the configuration of the frame transferring apparatus. As depicted in FIG. 3, the frame transferring apparatus 10 includes an input/output unit 20, a frame transmitting unit 30, a frame receiving unit 40, a transmission timing counter 50, a monitoring cycle counter 60, a frame analyzing unit 70, a frame generating unit 80, and a frame monitoring unit 90.

The input/output unit 20 inputs and outputs various information. Specifically, the input/output unit 20 has a single or plurality of ports, inputting and outputting a frame to and from a network.

The frame transmitting unit 30 transmits a frame. Specifically, the frame transmitting unit 30 transmits various frames including a CCM frame via the input/output unit 20.

The frame receiving unit 40 receives various frames. Specifically, upon reception of a frame via the input/output unit 20, the frame receiving unit 40 identifies the received frame.

Here, when obtaining the identification result that the received frame is either one of a CCM frame and a retransmission request frame, the frame receiving unit 40 transmits the CCM frame or the retransmission request frame to the frame monitoring unit 90.

Also, when obtaining the identification result that the received frame is neither a CCM frame nor a retransmission request frame, the frame receiving unit 40 transmits the received frame to a frame processing unit (not shown) for frame processing.

The transmission timing counter 50 transmits to the frame generating unit 80 a frame generation instruction for generating a frame every time a transmission timing counter value (post-transmission elapsed-time counter value) obtained by starting count-up after a CCM frame is transmitted last time reaches a predetermined counter value set in advance as a transmission interval.

Specifically, the transmission timing counter 50 has a timer for measuring time, counting up the transmission timing counter value by “1” every time a predetermined time has elapsed.

Then, when the transmission timing counter value counted up from “0” reaches the counter value (for example, “15”) set in advance by a Central Processing Unit (CPU) (not shown) as a transmission interval, the transmission timing counter 50 transmits a frame generation instruction to the frame generating unit 80.

Then, the transmission timing counter 50 returns the transmission timing counter value to “0”, restarting count-up of the transmission timing counter value from “0”.

Also, when accepting a retransmission instruction including an apparatus ID from the frame monitoring unit 90, the transmission timing counter 50 transmits a frame generation instruction including the apparatus ID for identifying the frame transferring apparatus 10 to the frame generating unit 80.

The monitoring cycle counter 60 transmits a check instruction for checking a non-arrival of a frame to the frame analyzing unit 70 every time a monitoring cycle counter value (post-check elapsed-time counter value) obtained by starting count-up after a non-arrival of a frame is checked last time reaches a predetermined counter value set in advance as a monitoring interval.

Specifically, the monitoring cycle counter 60 has a timer for measuring time, counting up the monitoring cycle counter value by “1” every time a predetermined time has elapsed.

Then, when the monitoring cycle counter value counted up from “0” reaches the counter value (for example, “15”) set in advance by a CPU (not shown) as a monitoring interval, the monitoring cycle counter 60 transmits a check instruction to the frame analyzing unit 70.

Then, the monitoring cycle counter 60 returns the monitoring cycle counter value to “0”, restarting count-up of the monitoring cycle counter value from “0”.

The frame analyzing unit 70 obtains from the CCM frame read and deleted from a buffer 91, which will be explained further below, an apparatus ID for identifying the frame transferring apparatus 10 of a transmission source of the CCM frame.

Every time the monitoring cycle counter value reaches the counter value as the monitoring interval, the frame analyzing unit 70 checks a non-arrival of a frame transferred among other frame transferring apparatuses 10 based on the apparatus ID obtained from the apparatus IDs obtained by the time the monitoring cycle counter value reaches the counter value as the monitoring interval.

Specifically, the frame analyzing unit 70 reads a CCM frame while deleting it from the buffer 91, which will be explained further below, and identifies the frame transferring apparatus 10 of a transmission source based on various parameters included in the CCM frame to obtain the apparatus ID of the identified frame transferring apparatus 10. The frame analyzing unit 70 then stores the obtained apparatus ID.

Then, upon accepting a check instruction from the monitoring cycle counter 60, the frame analyzing unit 70 determines based on each of the stored apparatus IDs whether all apparatus IDs of other frame transferring apparatuses have been obtained by the time the monitoring cycle counter value counted up from “0” reaches the counter value as the monitoring interval.

For example, the frame analyzing unit 70 has retained therein in advance the apparatus IDs of all frame transferring apparatuses 10 connected via the network, and match each stored apparatus ID with the retained apparatus IDS, thereby determining whether all apparatus IDS of other frame transferring apparatuses 10 have been obtained.

Here, if all apparatus IDs of the other frame transferring apparatuses 10 have been obtained, the frame analyzing unit 70 deletes the stored apparatus ID, and newly identifies the frame transferring apparatus 10 of a transmission source to obtain the apparatus ID of the identified frame transferring apparatus 10.

On the other hand, if there is an apparatus ID not yet obtained among the apparatus IDS of the frame transferring apparatuses to be obtained, the frame analyzing unit-70 issues an alarm indicating that a non-arrival of a frame among frame transferring apparatuses is detected. Note that the frame analyzing unit 70 can also be referred to as a first transferring-apparatus-information obtaining unit or a checking unit.

The frame generating unit 80 includes a CCM-frame generating unit 81 and a retransmission-request-frame generating unit 82.

The CCM-frame generating unit 81 generates a CCM frame to be transmitted to all other frame transferring apparatuses 10. Also, when accepting a request for retransmitting a CCM frame, the CCM-frame generating unit 81 generates a CCM frame to be transmitted to the frame transferring apparatus 10 of a requesting source.

Specifically, when accepting a frame generation instruction from the transmission timing counter 50, the CCM-frame generating unit 81 generates CCM frames to be transmitted in a multicast manner to all other frame transferring apparatuses 10. Then, the CCM-frame generating unit 81 transmits the generated CCM frames to the frame transmitting unit 30.

Also, when accepting a frame generation instruction including an apparatus ID from the transmission timing counter 50, the CCM-frame generating unit 81 generates a CCM frame to be transmitted in a unicast manner to the frame transferring apparatus 10 of a requesting source identified by the accepted apparatus ID. Note that the CCM-frame generating unit 81 can also be referred to as a check-frame transmitting unit or a check-frame retransmitting unit.

When a CCM frame is discarded, the retransmission-request-frame generating unit 82 requests the frame transferring apparatus 10 of a transmission source of the CCM frame to retransmit a CCM frame.

Specifically, when accepting a retransmission-request-frame generation instruction including an apparatus ID from a buffer monitoring unit 93, which will be explained further below, the retransmission-request-frame generating unit 82 generates a retransmission request frame to be transmitted to the frame transferring apparatus 10 identified by the accepted apparatus ID. Note that the retransmission-request-frame generating unit 82 can also be referred to as a retransmission requesting unit.

The frame monitoring unit 90 includes the buffer 91, a frame identifying unit 92, the buffer monitoring unit 93, and a retransmission requesting unit 94.

The buffer 91 has temporarily stored therein a CCM frame for checking a non-arrival of a frame. Specifically, the buffer 91 has temporarily stored therein a CCM frame stored by the buffer monitoring unit 93, and deletes a CCM frame read by the frame analyzing unit 70. Note that the buffer 91 can also be referred to as a check-frame storage unit.

The frame identifying unit 92 identifies the received frame. Specifically, the frame identifying unit 92 analyzes the frame accepted from the frame receiving unit 40 to identify the frame as either one of a CCM frame or a retransmission request frame.

Here, when identifying the accepted frame as a CCM frame, the frame identifying unit 92 transmits the accepted CCM frame to the buffer monitoring unit 93.

On the other hand, when identifying the accepted frame as a retransmission request frame, the frame identifying unit 92 transmits the accepted retransmission request frame to the retransmission requesting unit 94.

When a storage space for storing a CCM frame is left in the buffer 91, the buffer monitoring unit 93 stores the received CCM frame in the buffer 91. When no storage space for storing a CCM frame is left in the buffer 91, the buffer monitoring unit 93 discards the received CCM frame.

Specifically, the buffer monitoring unit 93 always monitors the buffer 91 and, when accepting a CCM frame from the frame identifying unit 92, determines whether a storage space for storing the CCM frame is left in the buffer 91.

When a storage space for storing the CCM frame is left in the buffer 91, the buffer monitoring unit 93 stores the CCM frame accepted from the frame identifying unit 92 in the buffer 91.

On the other hand, when no storage space for storing the CCM frame is left in the buffer 91, the buffer monitoring unit 93 obtains from the CCM frame accepted from the frame identifying unit 92 the apparatus ID of the frame transferring apparatus 10 of a transmission source, and then discards the CCM frame.

Then, the buffer monitoring unit 93 transmits a retransmission-request-frame generation instruction including the obtained apparatus ID to the retransmission-request-frame generating unit 82. Note that the buffer monitoring unit 93 can also be referred to as a check-frame discarding unit, a second transferring-apparatus-information obtaining unit, or a transferring-information storing unit.

When accepting a request for retransmitting a CCM frame, the retransmission requesting unit 94 retransmits the CCM frame to the requesting frame transferring apparatus 10.

Specifically, when accepting a retransmission request frame from the frame identifying unit 92, the retransmission requesting unit 94 obtains from the retransmission request frame the apparatus ID of the frame transferring apparatus of a transmission source.

Then, the retransmission requesting unit 94 transmits a retransmission instruction including the obtained apparatus ID to the transmission timing counter 50.

[Process by the Frame Transferring Apparatus]

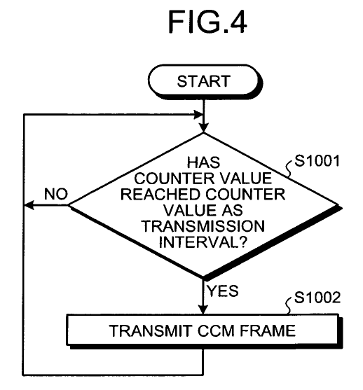

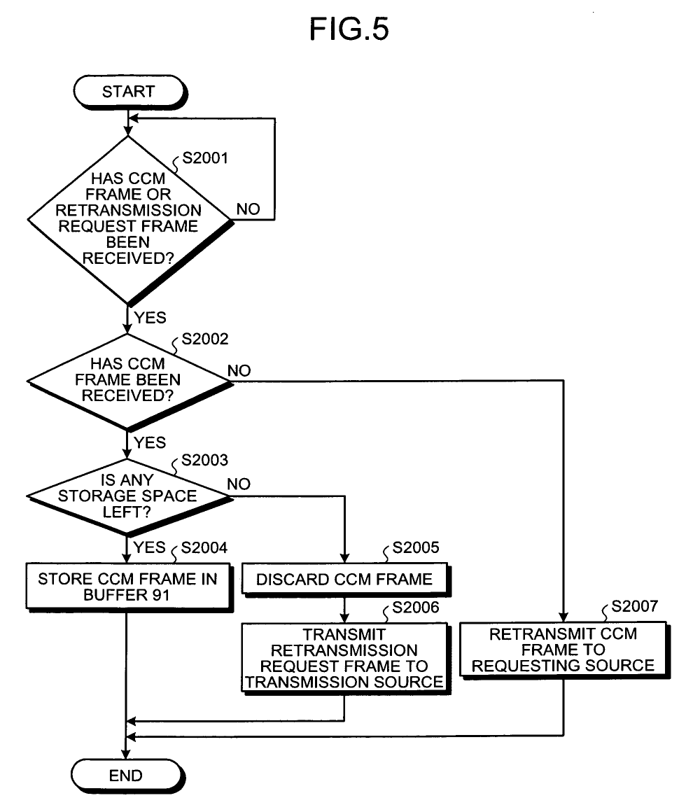

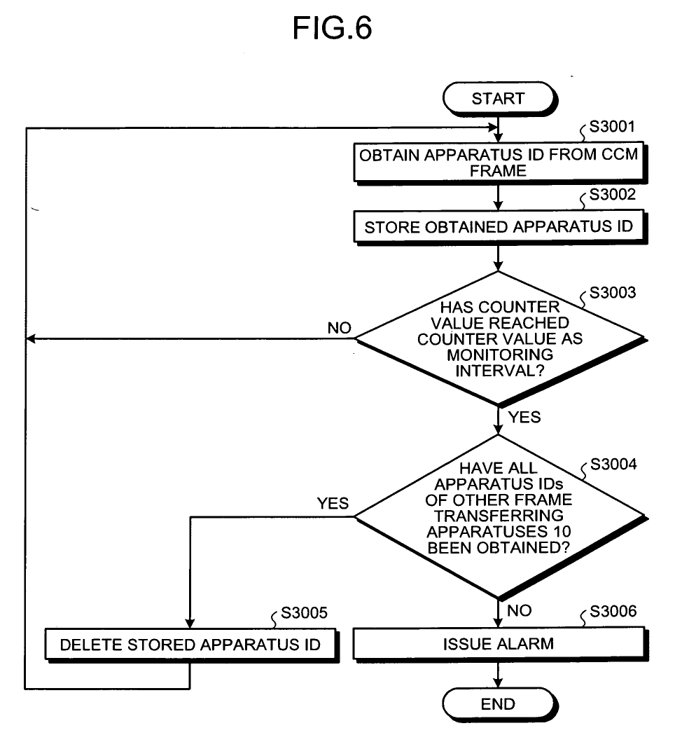

Next, the process of the frame transferring apparatus 10 is explained by using FIGS. 4 to 6. FIG. 4 is a flowchart depicting a flow of a CCM-frame transmitting process. FIG. 5 is a flowchart depicting a flow of a frame receiving process. FIG. 6 is a flowchart depicting a flow of a non-arrival checking process.

(CCM-Frame Transmitting Process)

As depicted in FIG. 4, when the transmission timing counter value reaches the counter value as the transmission interval (“Yes” at step S1001), the frame transferring apparatus 10 transmits CCM frames in a multicast manner to all other frame transferring apparatuses of transmission destinations (step S1002), and then waits until the transmission timing counter value again reaches the counter value as the transmission interval. On the other hand, when the transmission timing counter value does not reach the counter value as the transmission interval (“No” at step S1001), the frame transferring apparatus 10 waits until the transmission timing counter value reaches the counter value as the transmission interval. Note that the CCM-frame transmitting process by the frame transferring apparatus 10 ends as the driving of the frame transferring apparatus 10 stops.

(Frame Receiving Process)

As depicted in FIG. 5, when receiving a CCM frame or a retransmission request frame (“Yes” at step S2001), the frame transferring apparatus 10 analyzes the accepted frame (step S2002).

When the accepted frame is identified as a CCM frame (“Yes” at step S2002), the frame transferring apparatus 10 determines whether a storage space for storing the CCM frame is left in the buffer 91 (step S2003).

When a storage space for storing the CCM frame is left in the buffer 91 (“Yes” at step S2003), the frame transferring apparatus 10 stores the CCM frame in the buffer 91 (step S2004), and then ends the frame receiving process.

On the other hand, when no storage space for storing the CCM frame is left in the buffer 91 (“No” at step S2003), the frame transferring apparatus 10 discards the CCM frame (step S2005), and also transmits a retransmission request frame to the frame transferring apparatus 10 of a transmission source (step S2006), and then ends the frame receiving process.

Referring back to the explanation of step S2002, when identifying the accepted frame as a retransmission request frame (“No” at step S2002), the frame transferring apparatus 10 retransmits a CCM frame to the frame transferring apparatus 10 of a requesting source (step S2007), and then ends the frame receiving process.

(Non-Arrival Checking Process)

As depicted in FIG. 6, after the start of driving, the frame transferring apparatus 10 obtains from the CCM frame read and deleted from the buffer 91 the apparatus ID of the frame transferring apparatus 10 of a transmission source of the CCM frame (step S3001), and stores the obtained apparatus ID (step S3002).

Then, the frame transferring apparatus 10 repeats the process explained above (steps S3001 and S3002) until the monitoring cycle counter value reaches the counter value as the monitoring interval (“No” at step S3003).

Then, when the counted-up monitoring cycle counter value reaches the counter value as the monitoring interval (“Yes” at step S3003), the frame transferring apparatus 10 determines based on the stored apparatus IDs whether all apparatus IDs of other frame transferring apparatuses 10 have been obtained by the time the monitoring cycle counter value reaches the counter value as the monitoring interval (step S3004).

If all apparatus IDs of other frame transferring apparatuses 10 have been obtained (“Yes” at step S3004), the frame transferring apparatus 10 deletes the stored apparatus ID (step S3005), and again identifies the frame transferring apparatus 10 of a transmission source (step S3001).

On the other hand, if there is an apparatus ID not yet obtained among the apparatus IDs of other frame transferring apparatuses 10 to be obtained (“No” at step S3004), the frame transferring apparatus 10 issues an alarm indicative of a non-arrival of a frame (step S3006), and then ends the process.

### Effects of the First Embodiment

As explained above, according to the first embodiment, an erroneous detection of a non-arrival of a frame can be prevented. For example, the frame transferring apparatus 10 according to the first embodiment receives a CCM frame again from the frame transferring apparatus of a transmission source of the discarded frame, and therefore an erroneous detection of a non-arrival of a frame can be prevented.

### [b] Second Embodiment

Meanwhile, the frame transferring apparatus 10 according to the first embodiment transmits a CCM frame every time the transmission timing counter value reaches the counter value as the transmission interval. Therefore, arrival time zones of the CCM frames transmitted from other frame transferring apparatuses 10 may be synchronized every time, and therefore the transmitted CCM frame(s) may be discarded every time.

To get around this, in a second embodiment, the case of changing the timing of transmitting a CCM frame is explained. In the second embodiment, the configuration of the frame transferring apparatus 10 according to the second embodiment and a flow of the process by the frame transferring apparatus 10 are first explained, and then effects of the second embodiment are explained.

### Configuration of the Frame Transferring Apparatus According to the Second Embodiment

First, the configuration of the frame transferring apparatus 10 according to the second embodiment is explained. The configuration of the frame transferring apparatus 10 according to the second embodiment is different from the frame transferring apparatus 10 according to the first embodiment in the following points explained below.

The transmission timing counter 50 resets the transmission timing counter value at a predetermined value every time a CCM frame is transmitted.

Specifically, when accepting a retransmission instruction from the frame monitoring unit 90, the transmission timing counter 50 resets the transmission timing counter value at a counter value set in advance (for example, “0” or “2”), and also transmits a frame generation instruction to the frame generating unit 80.

### Process by the Frame Transferring Apparatus According to the Second Embodiment

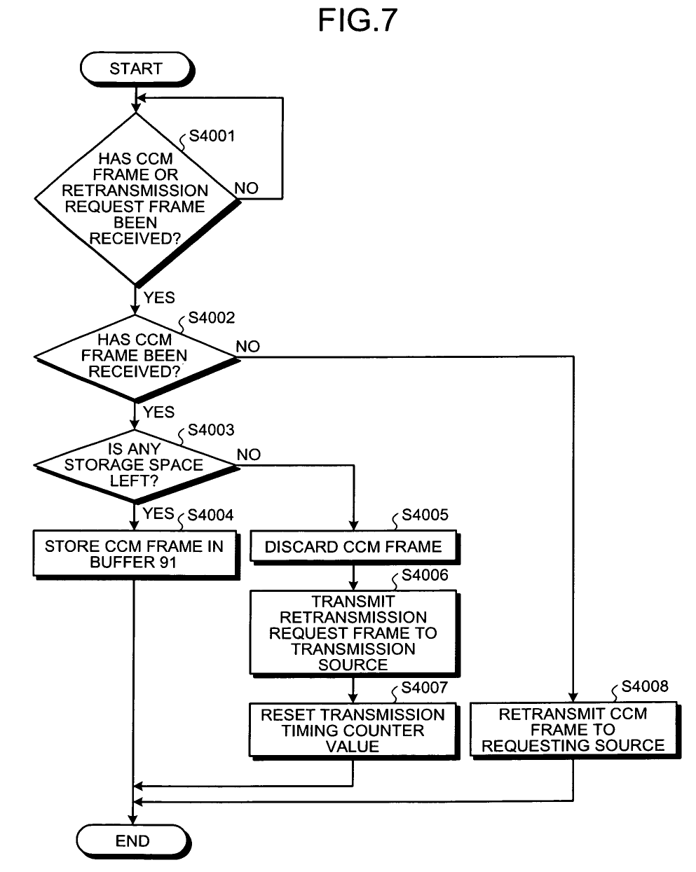

Next, the process by the frame transferring apparatus 10 according to the second embodiment is explained by using FIG. 7. FIG. 7 is a flowchart depicting a flow of a frame receiving process by the frame transferring apparatus according to the second embodiment. In the following, points different from the frame receiving process by the frame transferring apparatus according to the first embodiment are explained in detail.

As depicted in FIG. 7, when no storage space for storing a CCM frame is left in the buffer 91 (“No” at step S4003), the frame transferring apparatus 10 discards the CCM frame (step S4005), and also transmits a retransmission request frame to the frame transferring apparatus 10 of a transmission source (step S4006).

Then, the frame transferring apparatus 10 resets the transmission timing counter value at the predetermined value (step S4007), and then ends the frame receiving process.

### Effects of the Second Embodiment

As explained above, according to the second embodiment, it is possible to prevent the transmitted CCM frame from being discarded every time, thereby preventing an increase in traffic.

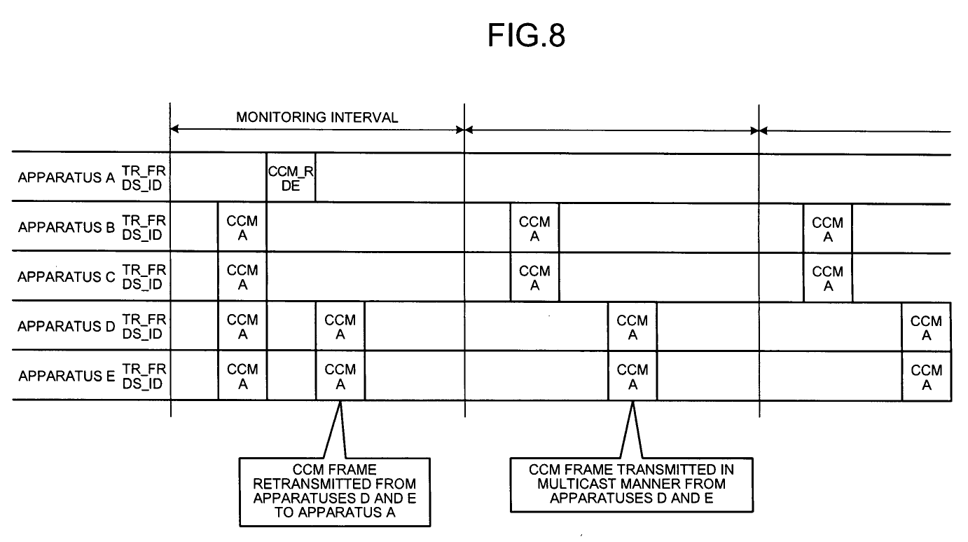

For example, as depicted in FIG. 8, the frame transferring apparatuses D and E accepting a request for retransmitting a CCM frame from the frame transferring apparatus A retransmits a CCM frame, and also resets the transmission timing counter value to the predetermined value.

Therefore, the frame transferring apparatuses D and E can shift the timing of transmitting the CCM frame in a multicast manner, thereby preventing the transmitted CCM frame from being discarded every time and preventing an increase in traffic. FIG. 8 is a drawing for explaining an effect of the second embodiment. In FIG. 8, apparatuses A to E are abbreviations for the frame transferring apparatuses A to E, respectively; TR_FR is the abbreviation for transmission frame; and DS_ID is the abbreviation for transmission destination ID.

### [c] Third Embodiment

Meanwhile, in the first and second embodiments, when a CCM frame is discarded, a retransmission request frame is transmitted to the frame transferring apparatus 10 of a transmission source of the discarded CCM frame.

A transmitting method of transmitting a retransmission request frame by the frame transferring apparatus 10 may includes a transmission method of transmitting retransmission request frames to a plurality of frame transferring apparatuses 10 all at once and a transmission method of transmitting a retransmission request frame every time a CCM frame is discarded. Either method can be adopted to apply the present invention.

In a third embodiment, the case is explained in which retransmission request frames are transmitted to a plurality of frame transferring apparatuses 10 all at once. In the third embodiment, the configuration of the frame transferring apparatus 10 according to the third embodiment and a flow of the process by the frame transferring apparatus 10 are first explained, and then effects of the third embodiment are explained.

### Configuration of the Frame Transferring Apparatus According to the Third Embodiment

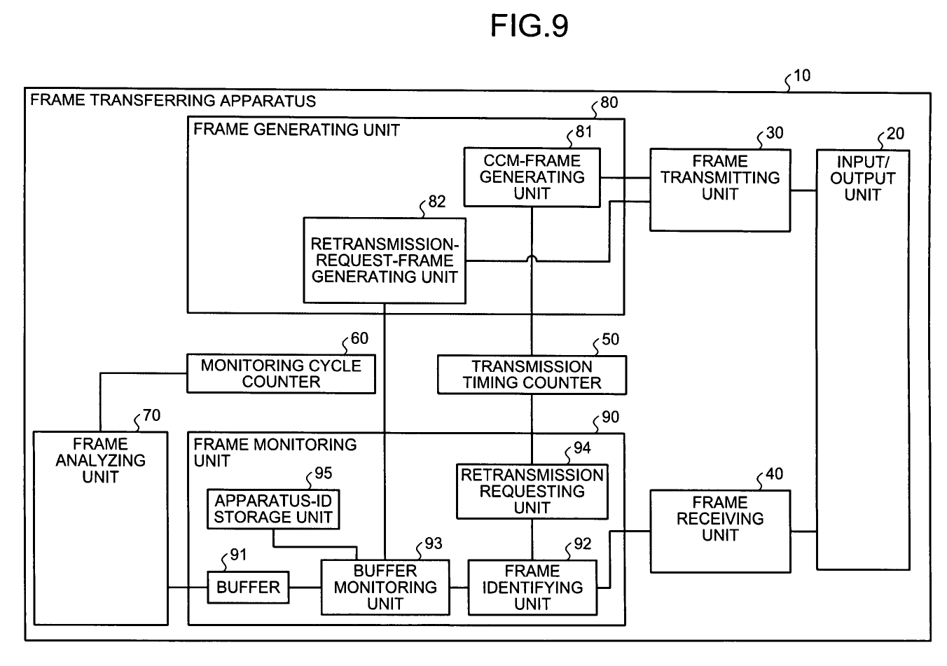

First, the configuration of the frame transferring apparatus 10 according to the third embodiment is explained by using FIG. 9. FIG. 9 is a block diagram of the configuration of the frame transferring apparatus according to the third embodiment. In addition to that an apparatus-ID storage unit 95 is newly provided, the configuration of the frame transferring apparatus 10 according to the third embodiment is different from the frame transferring apparatus 10 according to the second embodiment in the following points explained below.

Specifically, the apparatus-ID storage unit 95 stores therein an apparatus ID for identifying the frame transferring apparatus 10. More specifically, the apparatus-ID storage unit 95 has temporarily stored therein the apparatus ID stored by the buffer monitoring unit 93, and deletes the apparatus ID when a retransmission-request-frame generation instruction is transmitted from the buffer monitoring unit 93. Note that the apparatus-ID storage unit 95 can also be referred to as a transferring-apparatus-information storage unit.

Every time a CCM frame is discarded, the buffer monitoring unit 93 obtains from the CCM frame scheduled to be discarded the apparatus ID of the frame transferring apparatus 10 of a transmission source, and stores the obtained frame-transferring-apparatus information in the apparatus-ID storage unit 95.

Then, when a post-storage elapsed-time counter value indicative of an elapsed time from a time when an apparatus ID is first stored reaches a predetermined value set in advance, the buffer monitoring unit 93 requests each frame transferring apparatus 10 identified by all apparatus IDs stored in the apparatus-ID storage unit 95 to simultaneously request for retransmitting a CCM frame.

Specifically, when no storage space for storing a CCM frame is left in the buffer 91, the buffer monitoring unit 93 obtains from the CCM frame accepted from the frame identifying unit 92 the apparatus ID of the frame transferring apparatus 10 of a transmission source, and also discards the CCM frame.

Then, the buffer monitoring unit 93 stores the obtained apparatus ID in the apparatus-ID storage unit 95, and counts up the post-storage elapsed-time counter value by “1” every time the predetermined time has elapsed.

Then, when the post-storage elapsed-time counter value counted up from “0” reaches the counter value (for example, “2”) set in advance as a re-request timing, the buffer monitoring unit 93 reads each apparatus ID stored in the apparatus-ID storage unit 95, and returns the post-storage elapsed-time counter value to “0”.

The re-request timing is a time interval parameter-specified in advance for determining a timing of transmitting a retransmission request frame.

Also, if counting up the post-storage elapsed-time counter value has already been started, when the buffer monitoring unit 93 obtains from the CCM frame accepted from the frame identifying unit 92 the apparatus ID of the frame transferring apparatus 10 of a transmission source, the buffer monitoring unit 93 continues this counting-up of the post-storage elapsed-time counter value.

When accepting a retransmission-request-frame generation instruction including each apparatus ID from the buffer monitoring unit 93, the retransmission-request-frame generating unit 82 generates retransmission request frames to be transmitted to the frame transferring apparatuses 10 identified by the apparatus IDs all at once.

For example, the retransmission-request-frame generating unit 82 generates a plurality of identical retransmission request frames to be transmitted to each of the frame transferring apparatuses of transmission destinations identified by the apparatus IDs included in the retransmission-request-frame generation instruction.

### Process by the Frame Transferring Apparatus According to the Third Embodiment

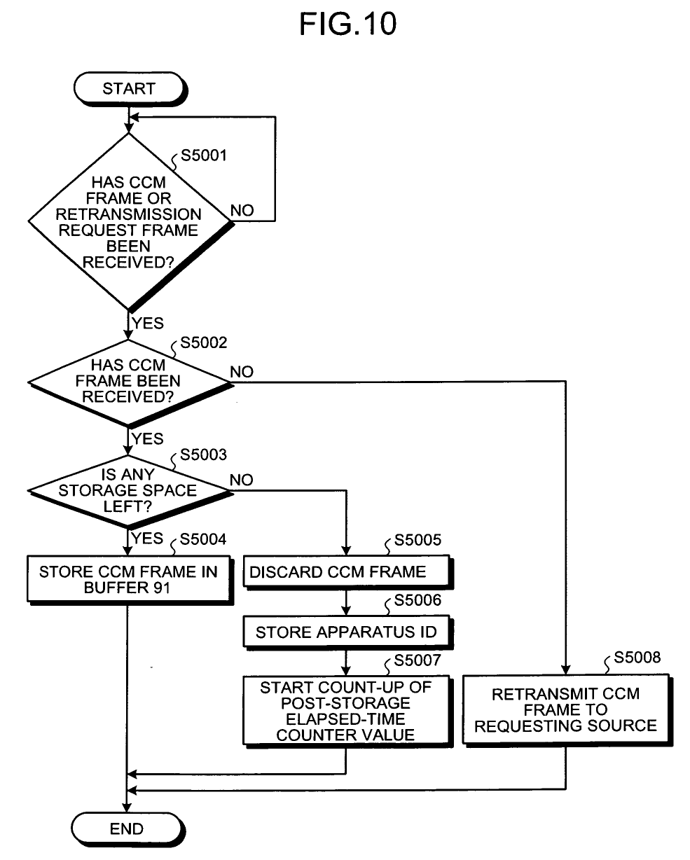

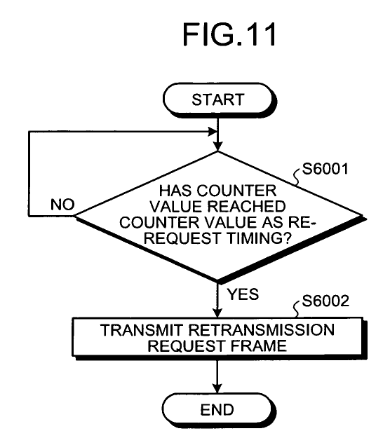

Next, the process of the frame transferring apparatus 10 according to the third embodiment is explained by using FIGS. 10 and 11. FIG. 10 is a flowchart depicting a flow of the frame receiving process by the frame transferring apparatus according to the third embodiment. FIG. 11 is a flowchart depicting a flow of a retransmission-request-frame transmitting process by the frame transferring apparatus according to the third embodiment.

(CCM-Frame Receiving Process)

Portions of a CCM-frame receiving process by the frame transferring apparatus according to the third embodiment that are different from those of the CCM-frame receiving process by the frame transferring apparatus according to the second embodiment are explained in detail.

As depicted in FIG. 10, when no storage space for storing a CCM frame is left in the buffer 91 (“No” at step S5003), the frame transferring apparatus 10 obtains from the CCM frame the apparatus ID of the frame transferring apparatus 10 of a transmission source, and also discards the CCM frame (step S5005).

Then, the frame transferring apparatus 10 stores the obtained apparatus ID (step S5006), starts count-up of the post-storage elapsed-time counter value (step S5007), and then ends the frame receiving process.

(Retransmission-Request-Frame Transmitting Process)

As depicted in FIG. 11, when the counted-up post-storage elapsed-time counter value reaches the counter value as the re-request timing (“Yes” at step S6001), the frame transferring apparatus 10 transmits the retransmission request frames to be transmitted all at once to each of the frame transferring apparatuses 10 identified by all stored apparatus IDs (step S6002), and then ends the retransmission-request-frame transmitting process.

### Effects of the Third Embodiment

As explained above, according to the third embodiment, it is possible to prevent an increase in traffic that would otherwise occur due to transmission of retransmission request frames.

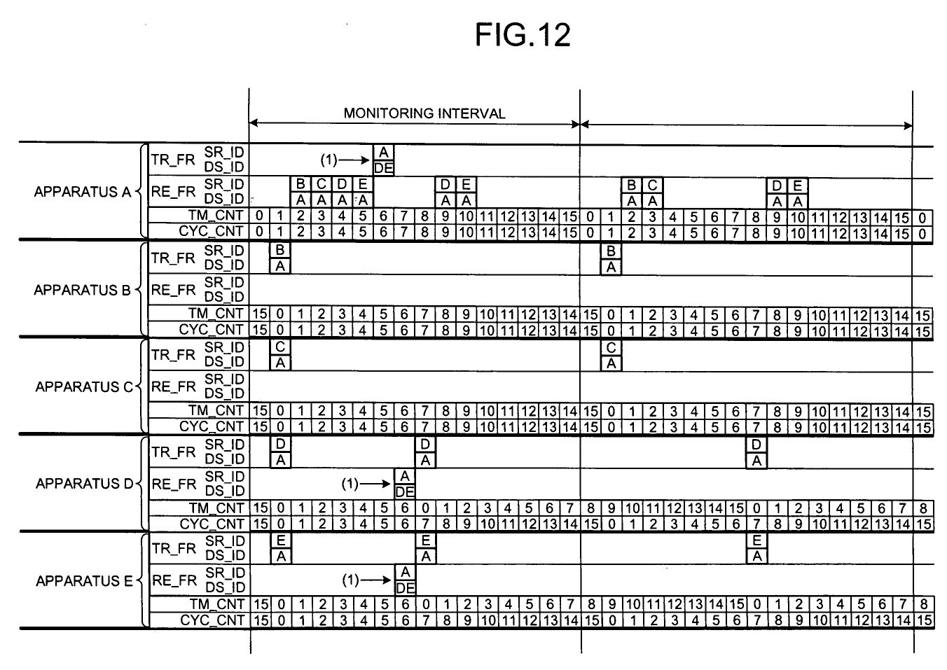

For example, as depicted in FIG. 12, the frame transferring apparatus A discards each CCM frame received from frame transferring apparatuses D and E among CCM frames successively received from frame transferring apparatuses B to E.

In this case, as depicted in (1) of FIG. 12, the frame transferring apparatus A transmits the retransmission request frames to be transmitted all at once to the frame transferring apparatuses D and E. Therefore, it is possible to prevent an increase in traffic that would otherwise occur due to transmission of retransmission request frames. FIG. 12 is a drawing for explaining an effect of the third embodiment. In FIG. 12, apparatuses A to E are abbreviations for the frame transferring apparatuses A to E, respectively; TR_FR is the abbreviation for transmission frame; SR_ID is the abbreviation for transmission source ID; DS_ID is the abbreviation for reception destination ID; TM_CNT is the abbreviation for the transmission timing counter; and CYC_CNT is the abbreviation for the monitoring cycle counter.

### [d] Fourth Embodiment

In a fourth embodiment, the case is explained in which a retransmission request frame is transmitted every time a CCM frame is discarded. In the fourth embodiment, the configuration of the frame transferring apparatus 10 according to the fourth embodiment is first explained, and then effects of the fourth embodiment are explained.

### Configuration of the Frame Transferring Apparatus According to the Fourth Embodiment

First, the configuration of the frame transferring apparatus 10 according to the fourth embodiment is explained. The configuration of the frame transferring apparatus 10 according to the fourth embodiment is different from the frame transferring apparatus 10 according to the second embodiment in the following points explained below.

The buffer monitoring unit 93 obtains from a CCM frame scheduled to be discarded the apparatus ID of the frame transferring apparatus 10 of a transmission source of the CCM frame every time a CCM frame is discarded. Then, the buffer monitoring unit 93 transmits a retransmission-request-frame generation instruction including the obtained apparatus ID to the retransmission-request-frame generating unit 82.

Every time accepting the retransmission-request-frame generation instruction including the obtained apparatus ID from the buffer monitoring unit 93, the retransmission-request-frame generating unit 82 generates a retransmission request frame to be transmitted to the frame transferring apparatus 10 identified by the accepted apparatus ID.

### Effects of the Fourth Embodiment

As explained above, according to the fourth embodiment, the possibility of preventing an erroneous detection of a non-arrival of a frame can be further increased.

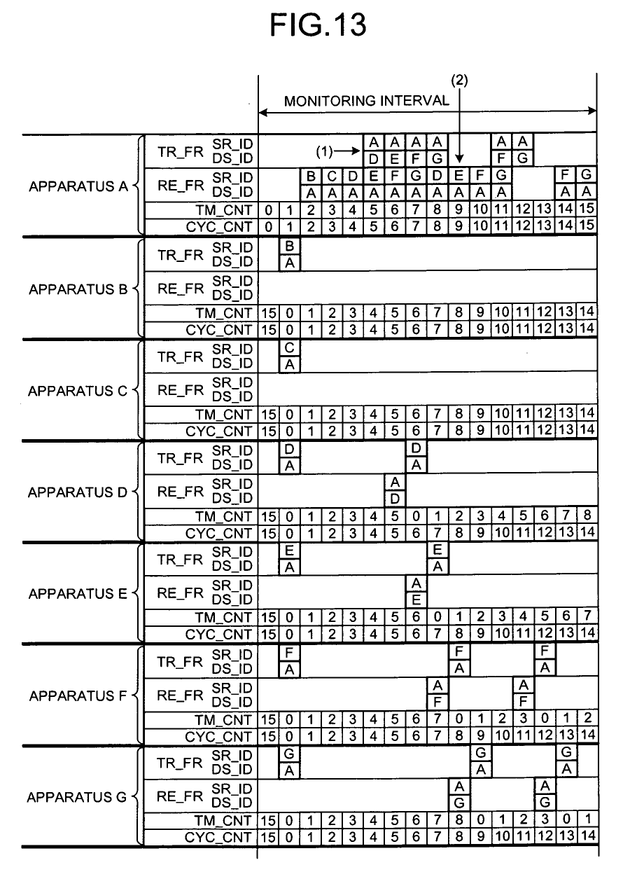

For example, as depicted in FIG. 13, the frame transferring apparatus A discards each CCM frame received from frame transferring apparatuses D to G among CCM frames successively received from frame transferring apparatuses B to G.

In this case, as depicted in (1) of FIG. 13, the frame transferring apparatus A transmits a retransmission request frame to each of the frame transferring apparatuses D to G when discarding their respective CCM frames.

Then, as depicted in (2) of FIG. 13, the frame transferring apparatus A successively receives CCM frames retransmitted from the frame transferring apparatuses D to G.

Therefore, the frame transferring apparatus A according to the fourth embodiment receives the retransmitted CCM frames without the occurrence of delays. With this, the possibility of receiving the retransmitted CCM frames by the time the counted-up time reaches the check time can be increased, thereby increasing the possibility of preventing an erroneous detection of a non-arrival of a frame. FIG. 13 is a drawing for explaining an effect of a fourth embodiment. FIG. 13 uses the same abbreviations as those of FIG. 12.

### [e] Fifth Embodiment

The first to fourth embodiments have been explained. However, the present invention may be practiced in various different forms other than the above embodiments. In the following, other embodiment will be explained as the fifth embodiment.

For example, in the first to fourth embodiments, the transmission timing counter value, the monitoring cycle counter value, and the post-storage elapsed-time counter value are counted up. However, the measuring method is not restricted to this. For example, the counter value set in advance may be counted down.

Also, in the third embodiment, the case is explained in which when the post-storage elapsed-time counter value reaches the counter value as the re-request timing, the retransmission request frames to be transmitted all at once are transmitted to the frame transferring apparatuses 10. However, the present invention is not restricted to this. For example, when the number of apparatus IDs stored in the apparatus-ID storage unit 95 reaches a predetermined number set in advance, retransmission request frames to be transmitted all at once may be transmitted to each of the frame transferring apparatuses 10.

Processing sequences, control sequences, concrete names, information including various data and parameters (for example, monitoring interval depicted in FIG. 12 and FIG. 13) depicted in the specification and drawings may be arbitrarily changed unless otherwise specified.

Each constituting element of each depicted apparatus is given in a functionally conceptual manner, and is not necessarily requested to be configured physically as illustrated in drawings. That is, concrete forms of distribution and integration of each apparatus are not limited to those illustrated in drawings, and the whole or part thereof may be functionally or physically distributed or integrated by appropriate units depending on various loads or use situations. For example, the transmission timing counter 50 and the monitoring cycle counter 60 depicted in FIG. 3 may be integrated.

Furthermore, each processing function executed by each apparatus may be fully or partly implemented by a CPU or a program analyzed and executed by the CPU, or implemented by hardware.

Also, the frame transferring method explained in the embodiments can be achieved by executing a program prepared in advance on a computer, such as a personal computer or work station. This program can be distributed over a network, such as the Internet. Furthermore, this program can be recorded on a computer-readable recording medium, such as a hard disk, flexible disk (FD), compact-disk read only memory (CD-ROM), magneto-optical disk (MO), and digital versatile disk (DVD), and can be read by the computer from the recording medium for execution.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A frame transferring apparatus comprising:
a check-frame storage unit that has temporarily stored therein a reception check frame for checking a non-arrival of a frame transferred among frame transferring apparatuses that transfer a frame;
a check-frame transmitting unit that transmits a transmission check frame to each of other frame transferring apparatuses connected via a network every time a post-transmission elapsed-time counter value indicative of an elapsed time from a time when a transmission check frame is transmitted last time reaches a predetermined value set in advance;
a check-frame discarding unit that, when a storage space for storing the reception check frame is left in the check-frame storage unit, stores the reception check frame received from the other frame transferring apparatus in the check-frame storage unit and, when no storage space for storing the reception check frame is left in the check-frame storage unit, discards the reception check frame received from the other frame transferring apparatus;
a first transferring-apparatus-information obtaining unit that obtains, from the reception check frame read and deleted from the check-frame storage unit, frame-transferring-apparatus information for identifying the frame transferring apparatus of a transmission source of the reception check frame;
a checking unit that, every time a post-check elapsed-time counter value indicative of a check elapsed time from a time when a non-arrival of a frame is checked last time reaches a predetermined value set in advance, checks a non-arrival of a frame transferred among the other frame transferring apparatuses based on the frame-transferring-apparatus information obtained by the first transferring-apparatus-information obtaining unit by the time when the post-check elapsed-time counter value reaches the predetermined value;
a retransmission requesting unit that, when the reception check frame is discarded by the check-frame discarding unit, requests the frame transferring apparatus of a transmission source of the discarded check frame to retransmit a check frame; and
a check-frame retransmitting unit that, when accepting a request for retransmitting the transmission check frame from the other frame transferring apparatus, retransmits the transmission check frame to the frame transferring apparatus of a requesting source.

2. The frame transferring apparatus according to claim 1, wherein
the check-frame transmitting unit resets the post-transmission elapsed-time counter value to a predetermined value every time the transmission check frame is retransmitted by the check-frame retransmitting unit.

3. The frame transferring apparatus according to claim 1, further comprising:
a transferring-apparatus-information storage unit that has stored therein frame-transferring-apparatus information for identifying the frame transferring apparatus of a requesting source of retransmission of the transmission check frame;
a second transferring-apparatus-information obtaining unit that, every time the reception check frame is discarded by the check-frame discarding unit, obtains frame-transferring-apparatus information for identifying the frame transferring apparatus of a transmission source of the reception check frame from the reception check frame scheduled to be discarded by the check-frame discarding unit; and
a transferring-apparatus-information storing unit that stores the frame-transferring-apparatus information obtained by the second transferring-apparatus-information obtaining unit in the transferring-apparatus-information storage unit, wherein
when a post-storage elapsed-time counter value indicative of an elapsed time from a time when the frame-transferring-apparatus information is first stored by the second transferring-apparatus-information obtaining unit in the transferring-apparatus-information storage unit reaches a predetermined value set in advance, the retransmission requesting unit requests each of the frame transferring apparatuses specified by all-frame-transferring-apparatus-information stored in the transferring-apparatus-information storage unit to simultaneously retransmit the check frame.

4. The frame transferring apparatus according to claim 1, further comprising a second transferring-apparatus-information obtaining unit that, every time the reception check frame is discarded by the check-frame discarding unit, obtains frame-transferring-apparatus information for identifying the frame transferring apparatus of a transmission source of the discarded check frame from the reception check frame scheduled to be discarded by the check-frame discarding unit, wherein
every time the frame-transferring-apparatus information is obtained by the second transferring-apparatus-information obtaining unit, the retransmission requesting unit requests the frame transferring apparatus specified by the frame-transferring-apparatus information to retransmit a check frame.

5. A frame transferring system comprising:
a frame transmitting apparatus that transmits a transmission frame including:
a check-frame transmitting unit that transmits a transmission check frame for checking a non-arrival of a frame to each of other frame transmitting apparatuses of connected via a network every time a post-transmission elapsed-time counter value indicative of an elapsed time from a time when a transmission check frame is transmitted last time reaches a predetermined value set in advance; and
a check-frame retransmitting unit that, when accepting a request for retransmitting the transmission check frame from a frame receiving apparatus, retransmits the transmission check frame to the frame receiving apparatus of a requesting source, and
the frame receiving apparatus that receives a reception frame including:
a check-frame storage unit that has temporarily stored therein reception check frames received from the other transmitting apparatuses connected via the network;
a check-frame discarding unit that, when a storage space for storing the reception check frame is left in the check-frame storage unit, stores the reception check frame received from the other frame transmitting apparatus in the check-frame storage unit and, when no storage space for storing the reception check frame is left in the check-frame storage unit, discards the reception check frame received from the other frame transmitting apparatus;
a first transmitting-apparatus-information obtaining unit that obtains from the reception check frame read and deleted from the check-frame storage unit frame-transmitting-apparatus information for identifying the frame transmitting apparatus of a transmission source of the reception check frame;
a checking unit that, every time a post-check elapsed-time counter value indicative of a check elapsed time from a time when a non-arrival of a frame is checked last time reaches a predetermined value set in advance, checks a non-arrival of a frame transferred among the other frame transmitting apparatuses based on the frame-transmitting-apparatus information obtained by the first transmitting-apparatus-information obtaining unit by the time when the post-check elapsed-time counter value reaches the predetermined value;
a retransmission requesting unit that, when the reception check frame is discarded by the check-frame discarding unit, requests the frame transmitting apparatus of a transmission source of the discarded check frame to retransmit a check frame.
